(19) United States
(12) Patent Application Publication
(10) Pub. No.: US 2022/0210376 A1
(43) Pub. Date: Jun. 30, 2022

(54) METHODS AND SYSTEMS FOR PROVIDING SECURITY MONITORING OF A PROCESSION AS THE PROCESSION MOVES ALONG A PROCESSION ROUTE

(71) Applicant: Honeywell International Inc., Charlotte, NC (US)

(72) Inventors: Kondamari Raja Pratap, Bangalore (IN); Shyamala Devi, Bangalore (IN); Saravanan Kumar, Bangalore (IN); Jayaraj Rajapandian, Bangalore (IN); Vivek Varma Bharath, Bangalore (IN); Anushka Srivastava, Bangalore (IN); Deepak Sundar Meganathan, Bangalore (IN); Pakkirisamy Suresh Kumar, Bangalore (IN)

(21) Appl. No.: 17/138,168

(22) Filed: Dec. 30, 2020

(51) Int. Cl. H04N 7/18; G06F 3/14; G08G 1/07; G08G 1/14; G01C 21/34; G01S 19/01

(52) U.S. Cl. CPC H04N 7/181; G06F 3/1446; G01S 19/01; G08G 1/146; G01C 21/3407; G08G 1/07

(57) ABSTRACT

A method of monitoring an event that is expected to progress along a planned event route includes receiving an indication of a current location of the event as the event progresses along the planned event route. Camera feeds that correspond to the current location of the event as the event progresses along the planned event route are automatically identified, selected and displayed on a situation awareness wall. Camera feeds that correspond to an expected future position of the event as the event progresses along the planned event route are automatically selected and displayed. Camera feeds that correspond to a previous position of the event as the event progresses along the planned event route are automatically removed from the situation awareness wall.

### TECHNICAL FIELD

The present disclosure relates to providing security monitoring for an event, and more particularly to methods and systems for providing security monitoring for a procession as the procession moves along a procession route.

### BACKGROUND

Large events such as processionals, VIP visits, sporting events such as marathon races and the like can require significant preparations before the event takes place to prepare for a variety of different security issues that may occur during the event. Preparations before the event can include mapping out a planned route, determining maintenance and security needs along the route, and monitoring for suspicious behavior before and during the event. A need remains for improved methods and systems for providing security monitoring for such an event, particularly as the event moves along the planned route.

### SUMMARY

The present disclosure relates to a methods and systems of providing security monitoring for an event, and more particularly to methods and systems for providing security monitoring for a procession as the procession moves along a procession route, particularly within smart cities that have security cameras distributed about the city. An example is a method of monitoring an event that is expected to progress along a planned event route, wherein the planned event route includes a plurality of video cameras that are positioned along the planned event route and capture a different aspect of the planned event route. A moveable reference that will remain with the event as the event progresses along the planned event route is assigned. A situation awareness wall layout is assigned for the event, wherein the situation awareness wall layout defines how a plurality of video feeds from selected ones of the plurality of video cameras are to be concurrently displayed on a situation awareness wall having one or more displays. A GPS or other location based signal is received from the moveable reference. A current position and a current movement of the event along the planned event route is determined from the GPS or other location based signal, where the current movement includes both a current speed and in some cases a current direction of the movable reference. One or more video feeds are automatically selected from the plurality of video cameras that are positioned along the planned event route for display on the situation awareness wall in accordance with the assigned situation awareness wall layout. The one or more video feeds are selected based at least in part on the current position of the event along the planned event route, and wherein the one or more video feeds selected for display include a video feed that correspond to a current position of the event along the planned event route and an expected future position of the event along the planned event route. One or more camera feeds that correspond to a previous position of the event along the planned event route are automatically removed from the situation awareness wall.

Another example method of monitoring an event that is expected to progress along a planned event route includes receiving an indication of a current location of the event as the event progresses along the planned event route. Camera feeds that correspond to the current location of the event as the event progresses along the planned event route are automatically identified, selected and displayed on a situation awareness wall. Camera feeds that correspond to an expected future position of the event as the event progresses along the planned event route are automatically selected and displayed. Camera feeds that correspond to a previous position of the event as the event progresses along the planned event route are automatically removed from the situation awareness wall.

Another example includes a non-transient, computer-readable storage medium having instructions stored thereon. When the instructions are executed by one or more processors, the one or more processors are caused to receive an indication of a current position of an event as the event progresses along a planned event route. The one or more processors are caused to automatically select and display camera feeds on a situation awareness wall that correspond to the current position of the event as the event progresses along the planned event route and to automatically select and display camera feeds on the situation awareness wall that correspond to an expected future position of the event as the event progresses along the planned event route. The one or more processors are caused to automatically remove from the situation awareness wall camera feeds that correspond to a previous position of the event as the event progresses along the planned event route.

The preceding summary is provided to facilitate an understanding of some of the features of the present disclosure and is not intended to be a full description. A full appreciation of the disclosure can be gained by taking the entire specification, claims, drawings, and abstract as a whole.

### BRIEF DESCRIPTION OF THE DRAWINGS

The disclosure may be more completely understood in consideration of the following description of various illustrative embodiments of the disclosure in connection with the accompanying drawings, in which:

FIG. 1 is a schematic block diagram of an illustrative system for monitoring an event along an event route;

FIG. 2 is a schematic diagram of an illustrative situation awareness wall layout;

FIG. 3 is a flow diagram showing an illustrative method of monitoring an event;

FIG. 4 is a flow diagram showing an illustrative method of automatically displaying surveillance cameras;

FIG. 5 is a flow diagram showing an illustrative method of updating social media analytics;

FIG. 6 is a flow diagram showing an illustrative method of determining route and parking assignments for emergency vehicles;

FIG. 7 is a flow diagram showing an illustrative method of automatically enabling video analytics;

FIG. 8 is a flow diagram showing an illustrative method of commanding traffic systems;

FIG. 9 is a flow diagram showing an illustrative method of monitoring an event;

FIG. 10 is a flow diagram showing an illustrative method of monitoring an event; and

FIG. 11 is a flow diagram showing an illustrative method of monitoring an event.

While the disclosure is amenable to various modifications and alternative forms, specifics thereof have been shown by way of example in the drawings and will be described in detail. It should be understood, however, that the intention is not to limit aspects of the disclosure to the particular illustrative embodiments described. On the contrary, the intention is to cover all modifications, equivalents, and alternatives falling within the spirit and scope of the disclosure.

### DESCRIPTION

The following description should be read with reference to the drawings wherein like reference numerals indicate like elements. The drawings, which are not necessarily to scale, are not intended to limit the scope of the disclosure. In some of the figures, elements not believed necessary to an understanding of relationships among illustrated components may have been omitted for clarity.

All numbers are herein assumed to be modified by the term “about”, unless the content clearly dictates otherwise. The recitation of numerical ranges by endpoints includes all numbers subsumed within that range (e.g., 1 to 5 includes 1, 1.5, 2, 2.75, 3, 3.80, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

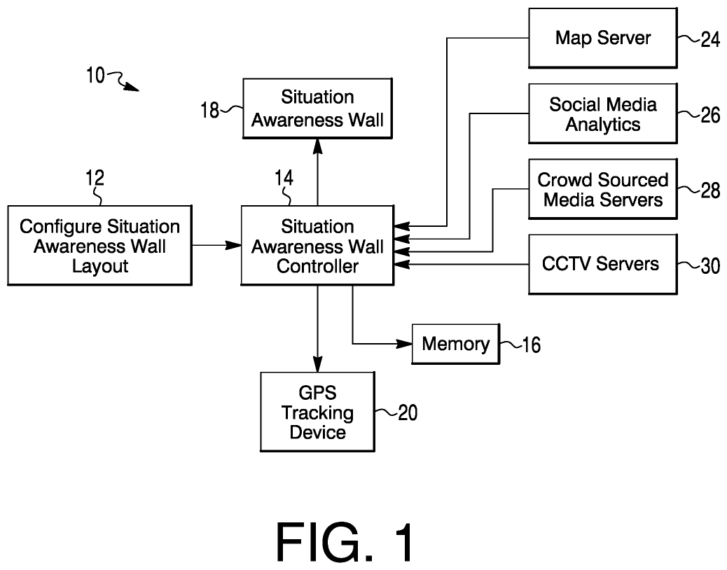

Planning and monitoring a large event such as processionals, VIP (Very Important Person) visits, sporting events such as marathon races and the like can require significant preparations before the event takes place to prepare for a variety of different issues that may arise during the event. The disclosure is directed to methods and systems for facilitating the planning for large events as well as providing security monitoring during such events. FIG. 1 provides a schematic block diagram of a system 10 that may be used in planning for a large event as well as providing security monitoring during the event. When an upcoming event is being planned, a control room operator can configure a situation awareness wall layout, as indicated at block 12, and can communicate the situation awareness wall layout to a situation awareness wall controller 14. The situation awareness wall controller 14 may store the configuration for the situation awareness wall layout in a memory 16 that is operably coupled to the situation awareness wall controller 14. In some cases, for example, the situation awareness wall controller 14 and the memory 16 may be part of a computer such as a laptop computer, a desktop computer or a server. A control room operator may use that same computer when planning out and creating the situation awareness wall layout, for example, or could use a separate computer.

The situation awareness wall layout will control where and how various camera feeds (and sometimes other information) will be displayed on a situation awareness wall 18. The situation awareness wall 18 may include a number of monitors, for example, each of which are under the control of the situation awareness wall controller 14. In some cases, the situation awareness wall 18 may include a number of relatively smaller monitors, with perhaps one or maybe two camera feeds displayed on each of the monitors. In some cases, the situation awareness wall 18 may include relatively larger monitors, each of which are sub-divided to display two, four, eight or more different camera feeds at the same time, with each camera feed displayed in a distinct sub-division of one of the monitors. In some cases, the situation awareness wall 18 may include just one large monitor that is sub-divided to display two, four, eight or more different camera feeds at the same time, with each camera feed displayed in a distinct sub-division of the large monitor. These are just examples.

It will be appreciated that planning the event, or more specifically, planning how to monitor the event, will include mapping out the route and then determining what assets and liabilities are present along the route. Assets may include video cameras as are commonly disposed throughout a smart city. Liabilities may include maintenance issues such as large potholes along the route, or spots where a street narrows or makes a sharp turn, for example, possibly creating security concerns. Additional liabilities may include portions of the route that lack video cameras, or perhaps have video cameras that are at least partially obscured by tree growth, billboards and the like. These are just some of the things that can be taken into account when planning the event route, and things that may need to be addressed before the event takes place.

The situation awareness wall 18 can display information from a variety of different sources. For example, the situation awareness wall controller 14 may communicate with a GPS or other location based tracking device 20. Accordingly, the situation awareness wall controller 14 is able to keep track of the progress of the event via the tracking device 20. In some instances, the situation awareness wall controller 14 may track the progress of the event along the route by having either a particular person associated with the event carry the tracking device 20 or have the tracking device 20 fixed to a vehicle or other object traveling with the event. In some cases, progress of the event may instead (or in addition to) be determined by analyzing camera feeds along the event route. Video analytics can be used to identify the event in a camera feed to determine the current position of the event along the route.

A map server 24 may be configured to provide the situation awareness wall controller 14 with a variety of maps that pertain to the planned route. In some instances, geographic information system (GIS) maps may be provided. GIS is a computer system for capturing, storing, checking and displaying data related to positions on Earth's surface. GIS can show many different kinds of data on one map, such as streets and buildings. The map server 24 may provide GIS maps that correspond to a current location of the event during the event. The map server 24 may also provide GIS maps that illustrate a contemplated event route.

In some cases, social media analytics 26 may be provided. Social media analytics 26 may be configured to receive a wide variety of social media information that may, for example, be posted by individuals along the event route during an event. Many social media platforms can identify a location of a device and a time when a posting is made, and may delivery to social media analytics 26 those postings that are identified as being along (e.g. with 1 mile) of the planned route, at a location near a current position of the event along the planned route, postings that are not necessarily near the event but are related to the event. These are just examples. Such postings may include positive messages such as “excited to attend the . . . event” and/or negative messages such as “I hate . . . the event”. It will be appreciated that social media may include Facebook® postings, Instagram® postings, Vine® postings, TIC TOC® postings and any of a number of different social platforms. Social media analytics 26 may be configured to receive a large number of potentially relevant social media platform posts, and analyze the posts looking for certain keywords or phrases, trends in such postings, activity level in such postings and/or any other suitable indicator(s) to possibly identify threats along the route. In some cases, a planned event with a relatively large volume of negative postings may be canceled or modified, or perhaps the event may take place but with enhanced security precautions.

Crowd sourced media servers 28 may be configured to receive live and/or recorded videos that may be uploaded by individuals along the event route. This can include videos uploaded by citizens attending the event route as well as event volunteers or event employees. In some cases, these videos can also be analyzed via video analytics to look for possible security concerns. For example, facial recognition analytics may be used to look for people that have been previously identified as being a possible security threat. In another example, video analytics may be used to identify guns, packages that are left alone, fighting, rioting, and/or other suspicious or unruly behavior.

CCTV (closed circuit television) servers 30 may be configured to receive camera feeds from hundreds or even thousands of video cameras that are disposed about a smart city. In some instances, a CCTV system may be referred to as a video surveillance system. The CCTV servers 30 may be configured to provide appropriate and relevant video feeds to the situation awareness wall controller 14 before, during and even after the event occurs. The CCTV servers 30 may receive images and/or video streams from hard-mounted video cameras. In some cases, the CCTV servers 30 may also receive images and/or video streams from handheld video cameras, video cameras mounted in emergency vehicles such as security vehicles and police vehicles, police body cameras, and the like. A source location of each of the video feeds may also be known to the CCTV servers 30.

The situation awareness wall controller 14 receives a number of different information streams from a number of different sources, including but not limited to the GPS tracking device 20, the map server 24, the social media analytics 26, the crowd sourced media servers 28 and the CCTV servers 30. The situation awareness wall controller 14 selects and assembles this information and displays the information on the situation awareness wall 18 in accordance with the situation awareness wall layout that was previously created and saved in the memory 16. One or more individuals may be positioned in front of the situation awareness wall 18 such that they can see all of the information that is displayed, and to respond if necessary to any apparent security concerns.

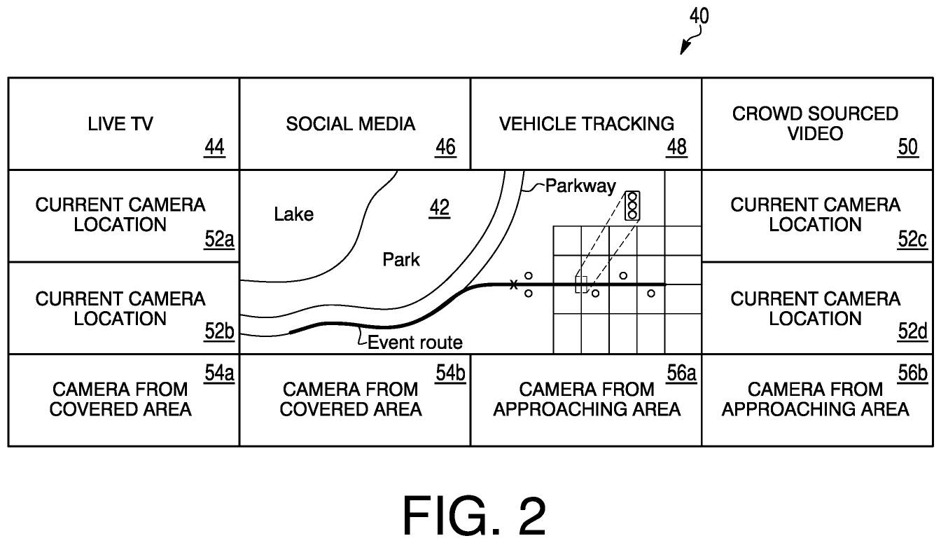

FIG. 2 is a schematic block diagram of an illustrative situation awareness wall layout 40 that may, for example, be displayed on the situation awareness wall 18 during an event. It will be appreciated that this is merely illustrative, and that an actual situation awareness wall layout may include additional images. In some cases, the situation awareness wall 18 may be ten, twenty, thirty or forty feet wide, and may be able to display many more things simultaneously than what is shown in the illustrative situation awareness wall layout 40. In some cases, a large map 42 may be displayed in the center of the situation awareness wall layout 40, with a number of camera feeds displayed around the perimeter. The map 42 may be a street map or a birds-eye view showing actual images. In some cases, the planned route may be superimposed or otherwise indicated on the map 42. Points of interest, such as the location of particular cameras, or points of possible concern, may also be indicated on the map 42 using various icons. In this particular example, the map 42 includes a portion of a lake that is located within a park. A parkway extends around a portion of the lake. The event route is indicated by a bolded line and extends along part of the parkway and onto side streets near the park. Camera locations are indicated on the map 42 via circles. Traffic signals may be indicated on the map 42. An asterisk marks the current location of the event along the event route.

In the illustrated situation awareness wall layout 40, a LIVE TV feed 44 may be displayed in the upper left corner. This may represent what is currently being broadcast by one or more television stations that are covering the event. A SOCIAL MEDIA feed 46 may be displayed that includes relevant social media posts as determined by the social media analytics 26. This can include, for example, both positive and negative posts, as desired. A VEHICLE TRACKING region 48 can include information pertaining to the current location and/or planned movement of emergency vehicles. In some cases, this can include a map with the current and/or planned future locations of each emergency vehicle indicated on the map. A CROWD SOURCED VIDEO feed 50 may be displayed in the upper right corner. Again, this is merely illustrated, and each of the LIVE TV feed 44, the SOCIAL MEDIA feed 46, the VEHICLE TRACKING region 48 and the CROWD SOURCED VIDEO feed 50 may each represent multiple images or video feeds.

The illustrative situation awareness wall layout 40 includes a number of CURRENT CAMERA LOCATION feeds 52 displayed on either side of the map 42. As shown, there are a total four CURRENT CAMERA LOCATION feeds individually labeled as 52a, 52b, 52c, 52d, but this is merely illustrative as the situation awareness wall 18 may accommodate more or less current camera feeds. In some instances, particularly when something happens unexpectantly during the event, the situation awareness wall layout 40 may modify itself to allow for additional CURRENT CAMERA LOCATION feeds 52 to be displayed, temporarily replacing at least some of the other displayed feeds 44, 46, 48, 50, 54a-54b, 56a-56b.

In the example shown, additional feeds are displayed along the bottom of the illustrative situation awareness wall layout 40. The situation awareness wall layout 40 may include CAMERA FROM COVERED LOCATION feeds 54, individually labeled as 54a and 54b. The CAMERA FROM COVERED LOCATION feeds 54 may include camera feeds showing an area that the event just passed through, before those camera feeds are completely removed. Likewise, the situation awareness wall layout 40 may include CAMERA FROM APPROACHING AREA feeds 56, individually labeled as 56a and 56b. The CAMERA FROM APPROACHING AREA feeds 56 may include camera feeds from an area that the event is expected to move into momentarily (e.g. within the next 15 minutes). This time period may be configurable, and in some cases may be as long as 30 minutes. In some cases, the situation awareness wall controller 14 may automatically update with no user input the camera feeds and/or other information that is displayed on the situation awareness wall 18 based on a current location of the event as received from the GPS tracking device 20 along the planned route.

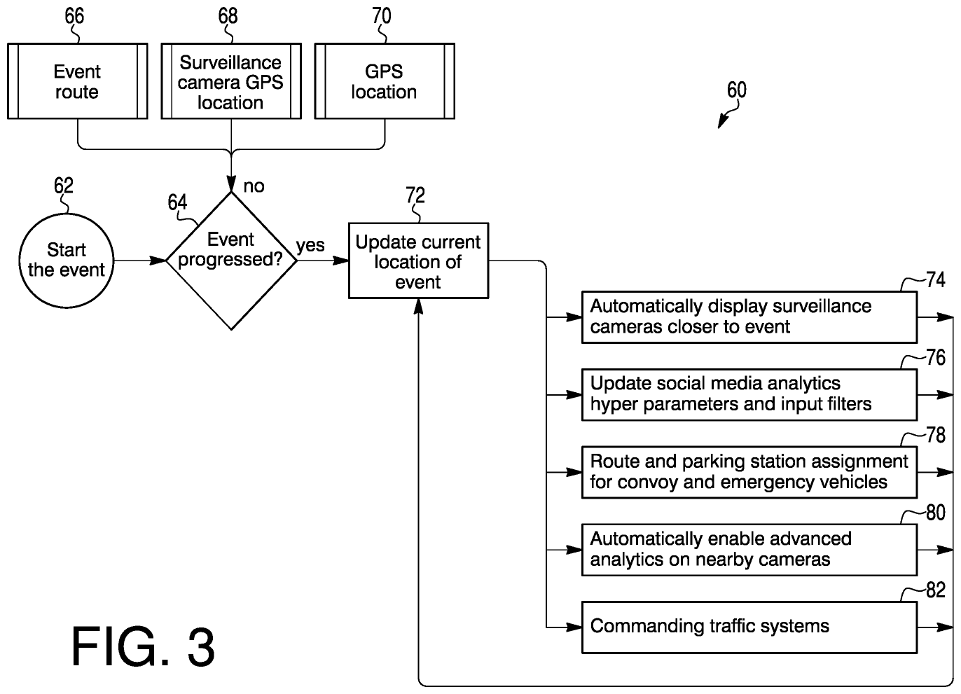

FIG. 3 is a flow diagram showing an illustrative method 60 of planning and monitoring an event. The event starts at block 62. Control passes to a decision block 64, where a determination is made as to whether the event has progressed. In some instances, this determination may be made by the situation awareness wall controller 14 or by another computer or device. Particular information may be provided for use in making the determination as to whether the event has progressed. An event route 66 block feeds route information to the decision block 64. A surveillance camera location block 68 informs the decision block 64 as to locations of each of the surveillance cameras while a GPS location block 70 informs the decision block 64 of the current location of the event.

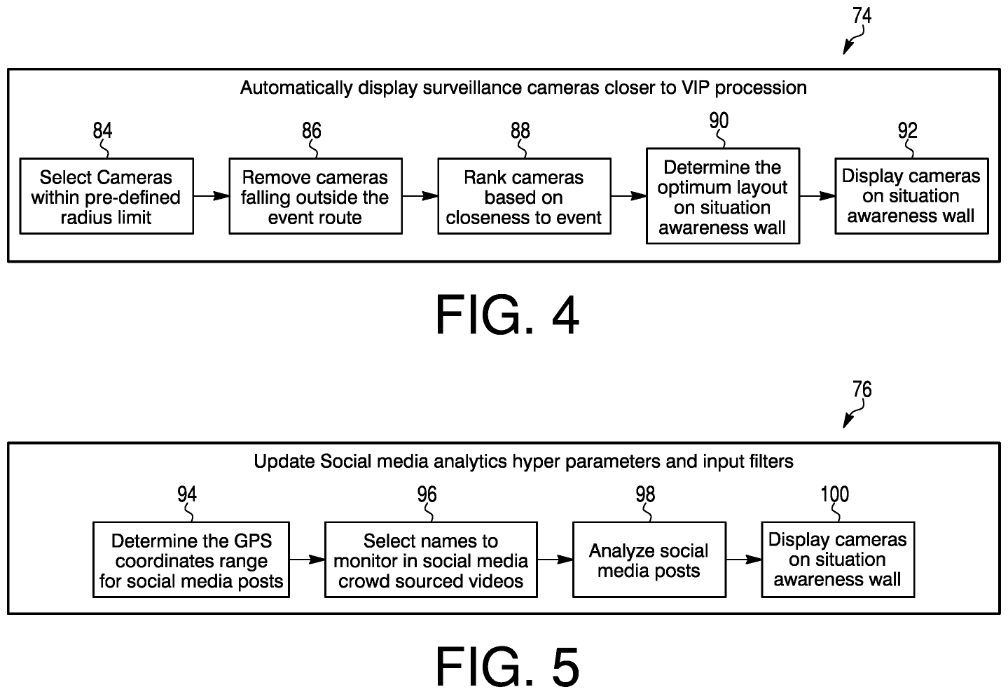

If at decision block 64 a determination is made that the event has progressed, meaning that the event has started and/or moved, control passes to block 72, where the current location of the event is updated. Once the current location of the event has been updated, a number of things occur, sometimes simultaneously. At block 74, the surveillance cameras closer to the event are displayed. At block 76, social media analytics parameters are updated (e.g. with new location). At block 78, route and parking stations for emergency vehicles are updated. At block 80, advanced analytics are enabled for nearby surveillance cameras. At block 82, traffic systems are commanded in order to facilitate movement of the event along the route. Each of these blocks 74, 76, 78, 80, 82 are described in greater detail in FIGS. 4 through 8.

FIG. 4 provides additional details regarding the method steps represented by block 74. Cameras that are within a predefined radius of a current location of the event are selected, as indicated at block 84. The predefined radius may be a radius of 500 meters, 250 meters, 100 meters, 50 meters or less of the current location of the event. The predefined radius may depend at least in part upon how quickly the event is moving. Rather than a radius, any other suitable distance metric may be used. For example, cameras that are within a predefined distance of the current location and have a field of view of the planned route of the event may be selected. In another example, cameras that are within two blocks of the current location and are within two blocks of the planned route of the event may be selected. In another example, cameras that has a field of view that corresponds to the current location may be selected. In some cases, a particular camera feed or view may be considered as corresponding to the current location of the event if at least 50 percent of the field of view of the particular camera includes a current view of the event. These are just examples.

Control passes to block 86, where camera feeds that are outside of the event route are removed. At bock 88, the camera feeds may be ranked in accordance with how close the corresponding camera field of view is to the event. In some cases, an optimal layout of the camera feeds may be determined, based at least in part upon their relative rankings, as indicated at block 90. In some instances, the camera feeds may be displayed on the situation awareness wall 18 in accordance with this optimal layout. It will be appreciated that in some cases, the situation awareness wall layout 40 may remain largely static, with certain camera feeds always displayed in a particular location. In some cases, the situation awareness wall layout 40 may be dynamic, and may change with respect to what camera feeds are displayed where, depending on what is happening with the event.

FIG. 5 provides additional details regarding the method steps represented by block 76. A determination is made as to the GPS coordinates of social media posts, as indicated at block 94. The GPS coordinates of each social media post may be provided by the social media platform. This may include pre-selecting which social media posts are of interest. In some cases, as indicated at block 96, particular names may be selected to monitor in both social media posts and crowd sourced videos. This may include people who are expected to be positive, such as celebrities, local journalists and the like. This may include people who are expected to be negative, and thus are being analyzed to look for any possible threats. The social media posts are analyzed, as indicated at block 98. Appropriate social media posts are displayed on the situation awareness wall 18, as indicated at block 100. This may also include crowd-sourced videos. In some instances, there may be a greater number of appropriate social media posts than can be displayed at one time on the situation awareness wall 18. In some cases, the appropriate social media posts may be ranked, and the highest-ranked posts may be displayed. Ranking may depend, for example, on how close the person posting a particular social media post is to the event route. Ranking may depend on the content of the particular social media post. As an example, a social media post making a threat may be ranked higher than a social media post expressing approval of the event.

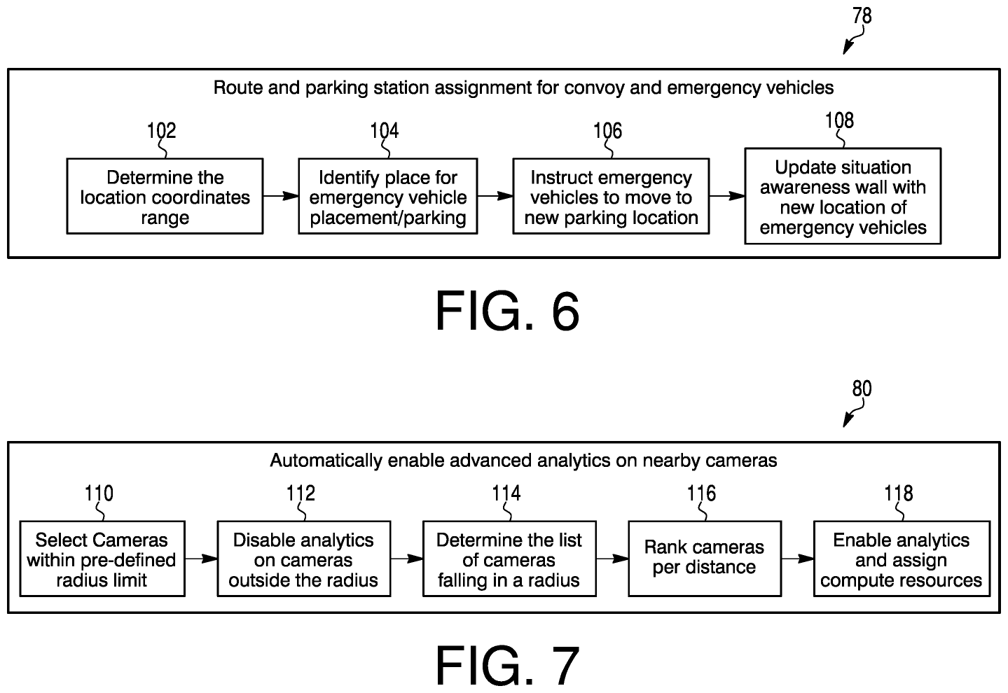

FIG. 6 provides additional details regarding the method steps represented by block 78. A determination is made as to a coordinates range for the current location of the event, as indicated at block 102. Appropriate locations for emergency vehicles to park are determined, as indicated at block 104. It will be appreciated that the appropriate locations are dynamic, and will change as the event moves through the event route. The system may automatically instruct the emergency vehicles to move to their new designated locations, as indicated at block 106. The situation awareness wall 18 is updated with the new locations of the emergency vehicles, as indicated at block 108.

FIG. 7 provides additional details regarding the method steps represented by block 80. Cameras within a predefined radius (or other measure) of the current location of the event are selected, as indicated at block 110. The predefined radius may be a radius of 500 meters, 250 meters, 100 meters, 50 meters or less of the current location of the event. The pre-defined radius (or other measure) may depend at least in part upon how quickly the event is moving. Analytics are disabled for any camera feeds that are outside of the predefined radius (or other measure), as indicated at block 112. A list of cameras that fall within the predefined radius (or other measure) is determined, as indicated at block 114. The cameras are ranked in accordance with relative distance, sight line or other relevance, as indicated at block 116. Analytics are enabled and computational resources are assigned to those with the highest ranking, as indicated at block 118.

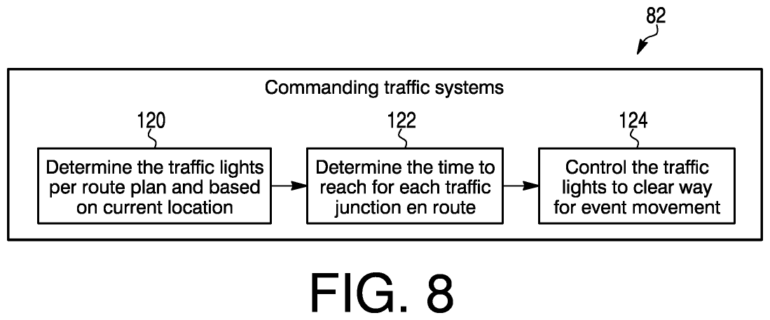

FIG. 8 provides additional details regarding the method steps represented by block 82. The traffic lights along the event route are determined, and proximity to the current location of the event are determined, as indicated at block 120. A determination is made as to how long it will take for the event to reach each traffic junction having a controllable traffic light, as indicated at block 122. The traffic lights are controlled in order to allow free movement of the event, as indicated at block 124. This can include keeping a light green longer than it normally would be, for example, or changing a red light to green earlier than it would normally change.

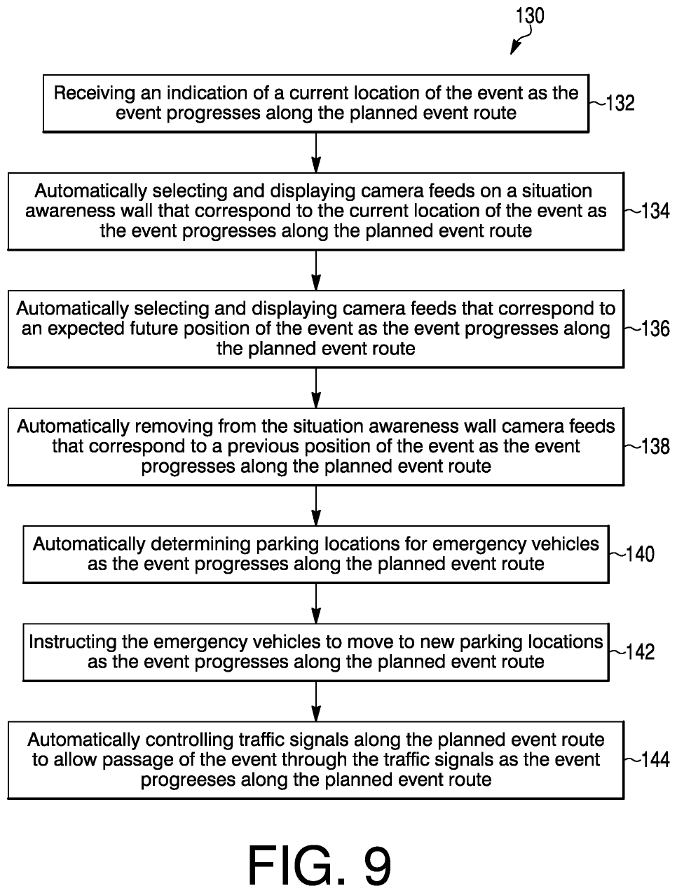

FIG. 9 is a flow diagram showing an illustrative method 130 of monitoring an event that is expected to progress along a planned event route. An indication of a current location of the event as the event progresses along the planned event route is received, as indicated at block 132. The indication of the current location of the event may be determined based at least in part upon analyzing one or more camera feeds captured along the planned event route showing the event. In some cases, the indication of the current location of the event may be determined via a GPS signal generated by a GPS tracking device (e.g. GPS tracking device 20) traveling with the event as the event progresses along the planned event route. Camera feeds that correspond to the current location of the event as the event progresses along the planned event route are automatically selected and displayed on a situation awareness wall, as indicated at block 134. A camera feed may be deemed to correspond to the current location of the event when at least 50 percent of a field of view of a particular camera includes a current view of the event, for example.

Camera feeds that correspond to an expected future location of the event as the event progresses along the planned event route are automatically selected and displayed on the situation awareness wall, as indicated at block 136. A camera feed may be deemed to correspond to the expected future position of the event when at least 50 percent of a field of view of a particular camera includes a view of where the event is expected to be within a configurable length of time. The configurable length of time may be as short as five minutes or as long as 30 minutes or longer. Camera feeds that correspond to a previous position of the event as the event progresses along the planned event route are automatically removed from the situation awareness wall, as indicated at block 138.

In some instances, the method 130 may further include automatically determining parking locations for emergency vehicles as the event progresses along the planned event route, as indicated at block 140. The method 130 may further include automatically instructing the emergency vehicles to move to new parking locations as the event progresses along the planned event route, as indicated at block 142. In some instances, traffic signals along the planned event route may be automatically controlled to allow passage of the event through the traffic signals as the event progresses along the planned event route, as indicated at block 144.

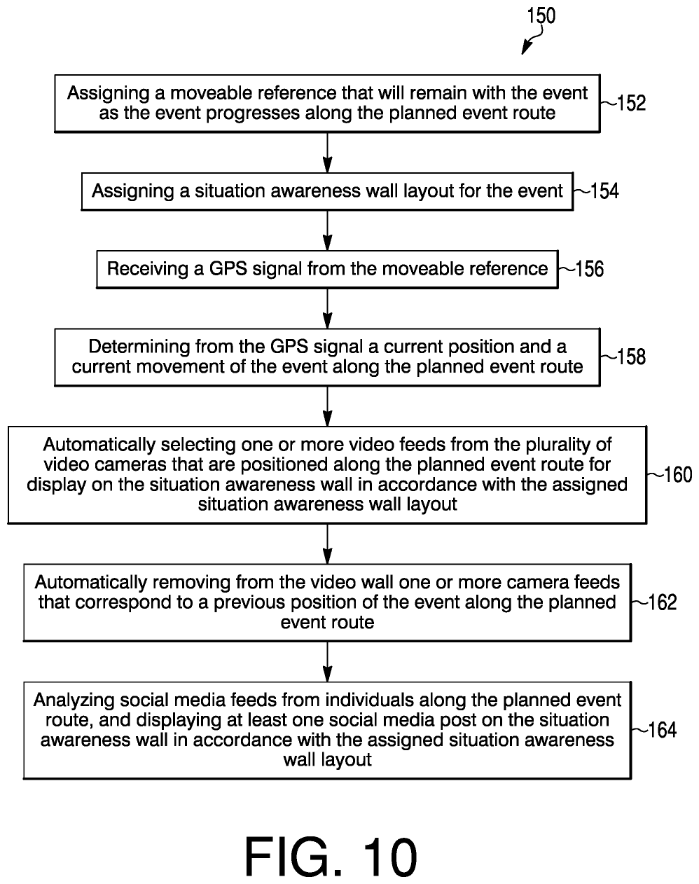

FIG. 10 is a flow diagram showing an illustrative method 150 of monitoring an event that is expected to progress along a planned event route, wherein the planned event route includes a plurality of video cameras that are positioned along the planned event route and capture a different aspect of the planned event route. A moveable reference that will remain with the event as the event progresses along the planned event route is assigned, as indicated at block 152. The moveable reference may include a wearable GPS tag worn or carried by a person traveling with the event. The moveable reference may include a vehicle including GPS tracking, and/or any other GPS tracking device 20.

A situation awareness wall layout for the event is assigned for the event, as indicated at block 154. The situation awareness wall layout may define how a plurality of video feeds from selected ones of the plurality of video cameras are to be concurrently displayed on a situation awareness wall having one or more displays. A GPS or other location based signal is received from the moveable reference, as indicated at block 156. A current position and a current movement of the event along the planned event route is determined from the GPS or other location based signal, as indicated at block 158. In some cases, current movement is considered to include both a current speed and a current direction of movement of the movable reference.

One or more video feeds from the plurality of video cameras that are positioned along the planned event route are automatically selected for display on the situation awareness wall in accordance with the assigned situation awareness wall layout, as indicated at block 160. The one or more video feeds may be selected based at least in part on the current position of the event along the planned event route, and wherein the one or more video feeds selected for display include a video feed that correspond to a current position of the event along the planned event route and an expected future position of the event along the planned event route. One or more camera feeds that correspond to a previous position of the event along the planned event route are automatically removed from the situation awareness wall, as indicated at block 162.

In some instances, the method 150 may further include confirming and when necessary updating the current speed at which the event is currently moving in order to account for unexpected changes in the current speed/location. In some cases, the planned event route may be updated when the event is detected as deviating from the planned event route. The event may include a processional that is passing along the planned event route. The event may, for example, be a VIP (very important person) travelling along the planned event route. The planned event route may include an outdoor route along one or more streets or sidewalks, and is greater than 1 mile in length. In some cases, the method 150 may further include analyzing social media feeds from individuals along the planned event route, and displaying at least one social media post on the situation awareness wall in accordance with the assigned situation awareness wall layout, as indicated at block 164.

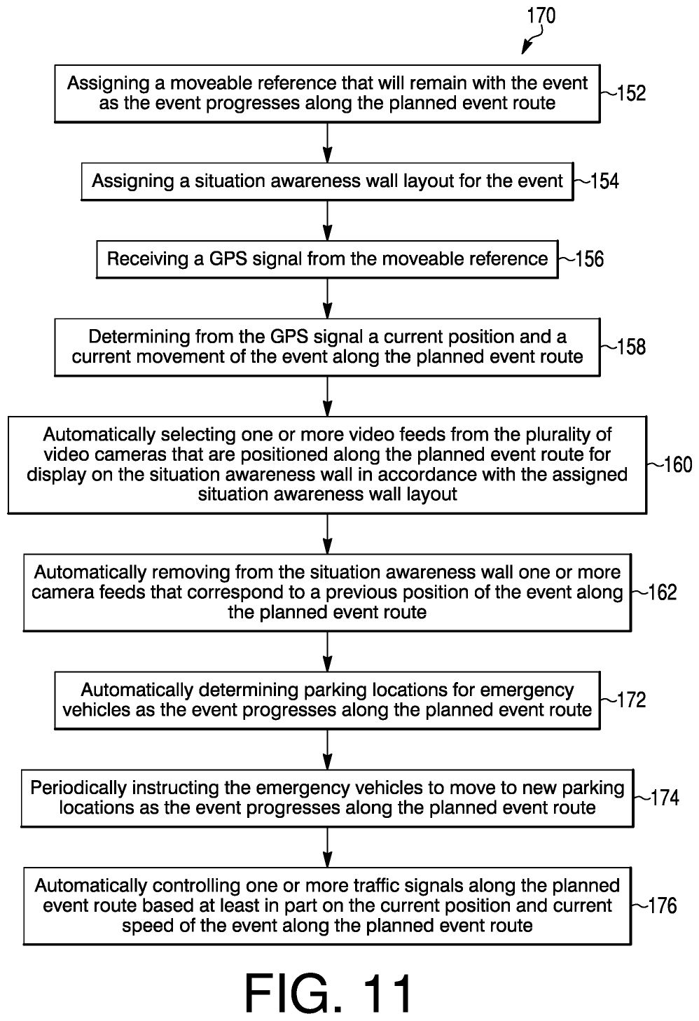

FIG. 11 is a flow diagram showing an illustrative method 170 of monitoring an event that is expected to progress along a planned event route, wherein the planned event route includes a plurality of video cameras that are positioned along the planned event route and capture a different aspect of the planned event route. A moveable reference that will remain with the event as the event progresses along the planned event route is assigned, as indicated at block 152. The moveable reference may include a wearable GPS tag worn or carried by a person traveling with the event. The moveable reference may include a vehicle including GPS tracking and/or any other GPS tracking device 20.

A situation awareness wall layout for the event is assigned for the event, as indicated at block 154. The situation awareness wall layout may define how a plurality of video feeds from selected ones of the plurality of video cameras are to be concurrently displayed on a situation awareness wall having one or more displays. A GPS or other location based signal is received from the moveable reference, as indicated at block 156. A current position and a current movement of the event along the planned event route is determined from the GPS or other location based signal, as indicated at block 158. In some cases, current movement is considered to include both a current speed and a current direction of movement of the movable reference.

One or more video feeds from the plurality of video cameras that are positioned along the planned event route are automatically selected for display on the situation awareness wall in accordance with the assigned situation awareness wall layout, as indicated at block 160. The one or more video feeds may be selected based at least in part on the current position of the event along the planned event route, and wherein the one or more video feeds selected for display include a video feed that corresponds to a current position of the event along the planned event route and a video feed that corresponds to an expected future position of the event along the planned event route. One or more camera feeds that correspond to a previous position of the event along the planned event route are automatically removed from the situation awareness wall, as indicated at block 162.

In some instances, the method 170 may further include automatically determining parking locations for emergency vehicles as the event progresses along the planned event route, as indicated at block 172. The emergency vehicles may be automatically instructed to move to new parking locations as the event progresses along the planned event route, as indicated at block 174. In some cases, this may include calculating vehicle routes for the emergency vehicles to take while moving to the new parking locations. In some cases, as indicated at block 176, one or more traffic signals along the planned event route may be automatically controlled based at least in part on the current position and current speed of the event along the planned event route.

Those skilled in the art will recognize that the present disclosure may be manifested in a variety of forms other than the specific embodiments described and contemplated herein. Accordingly, departure in form and detail may be made without departing from the scope and spirit of the present disclosure as described in the appended claims.

What is claimed is:

1. A method of monitoring an event that is expected to progress along a planned event route, wherein the planned event route includes a plurality of video cameras that are positioned along the planned event route and capture a different aspect of the planned event route, the method comprising:
assigning a moveable reference that will remain with the event as the event progresses along the planned event route;
assigning a situation awareness wall layout for the event, wherein the situation awareness wall layout defines how a plurality of video feeds from selected ones of the plurality of video cameras are to be concurrently displayed on a situation awareness wall having one or more displays;
receiving a GPS signal from the moveable reference;
determining from the GPS signal a current position and a current movement of the event along the planned event route, wherein the current movement includes both a current speed of the movable reference;
automatically selecting one or more video feeds from the plurality of video cameras that are positioned along the planned event route for display on the situation awareness wall in accordance with the assigned situation awareness wall layout, the one or more video feeds are selected based at least in part on the current position of the event along the planned event route, and wherein the one or more video feeds selected for display include a video feed that correspond to a current position of the event along the planned event route and an expected future position of the event along the planned event route; and
automatically removing from the situation awareness wall one or more camera feeds that correspond to a previous position of the event along the planned event route.

2. The method of claim 1, further comprising confirming and when necessary updating the current speed at which the event is currently moving in order to account for unexpected changes in the current speed.

3. The method of claim 1, further comprising updating the planned event route when the event deviates from the planned event route.

4. The method of claim 1, wherein the event comprises a processional passing along the planned event route.

5. The method of claim 1, wherein the event comprises a VIP traveling along the planned event route.

6. The method of claim 1, wherein the moveable reference comprises a wearable GPS tag worn or carried by a person traveling with the event or a vehicle including GPS tracking.

7. The method of claim 1, further comprising analyzing social media feeds from individuals along the planned event route, and displaying at least one social media post on the situation awareness wall in accordance with the assigned situation awareness wall layout.

8. The method of claim 7, further comprising ranking the social media feeds and displaying the highest ranked social media feeds.

9. The method of claim 1, further comprising:
automatically determining parking locations for emergency vehicles as the event progresses along the planned event route; and
periodically instructing the emergency vehicles to move to new parking locations as the event progresses along the planned event route.

10. The method of claim 9, further comprising calculating vehicle routes for the emergency vehicles to take while moving to the new parking locations.

11. The method of claim 1, further comprising:
automatically controlling one or more traffic signals along the planned event route based at least in part on the current position and current speed of the event along the planned event route.

12. The method of claim 1, wherein the planned event route comprises an outdoor route along one or more streets or sidewalks, and is greater than 1 mile in length.

13. A method of monitoring an event that is expected to progress along a planned event route, the method comprising:
receiving an indication of a current location of the event as the event progresses along the planned event route;
automatically selecting and displaying camera feeds on a situation awareness wall that correspond to the current location of the event as the event progresses along the planned event route;
automatically selecting and displaying camera feeds that correspond to an expected future position of the event as the event progresses along the planned event route; and
automatically removing from the situation awareness wall camera feeds that correspond to a previous position of the event as the event progresses along the planned event route.

14. The method of claim 13, wherein the indication of the current location of the event is determined based at least in part by analyzing one or more camera feeds captured along the planned event route showing the event.

15. The method of claim 13, wherein the indication of the current location of the event is determined via a GPS signal generated by a GPS device traveling with the event as the event progresses along the planned event route.

16. The method of claim 13, wherein a camera feed is deemed to correspond to the current location of the event when at least 50 percent of a field of view of a particular camera includes a current view of the event.

17. The method of claim 13, wherein a camera feed is deemed to correspond to the expected future position of the event when at least 50 percent of a field of view of a particular camera includes a view of where the event is expected to be within a configurable length of time.

18. A non-transient, computer-readable storage medium having stored thereon instructions that when executed by one or more processors causes the one or more processors to:
receive an indication of a current position of an event as the event progresses along a planned event route;
automatically select and display camera feeds on a situation awareness wall that correspond to the current position of the event as the event progresses along the planned event route;
automatically select and display camera feeds on the situation awareness wall that correspond to an expected future position of the event as the event progresses along the planned event route; and
automatically remove from the situation awareness wall camera feeds that correspond to a previous position of the event as the event progresses along the planned event route.

19. The non-transient, computer-readable storage medium of claim 18, wherein the one or more processors are further caused to:
automatically determine parking locations for emergency vehicles as the event progresses along the planned event route; and
instruct the emergency vehicles to move to new parking locations as the event progresses along the planned event route.

20. The non-transient, computer-readable storage medium of claim 18, wherein the one or more processors are further caused to:
automatically control traffic signals along the planned event route to allow passage of the event through the traffic signals as the event progresses along the planned event route.
